(19) United States
(12) Patent Application Publication
(10) Pub. No.: US 2026/0366170 A1
(43) Pub. Date: Nov. 19, 2026

(54) METHOD FOR PRODUCING HYDROGEN GAS FROM WATER AND DEVICE FOR CARRYING OUT THE METHOD

(71) Applicant: Anders OLSSON, Esher (GB)

(72) Inventor: Anders OLSSON, Esher (GB)

(21) Appl. No.: 19/488,202

(22) PCT Filed: May 26, 2024
(86) PCT No.: PCT/SE2024/050515

§ 371 Date: Nov. 26, 2025

(30) Foreign Application Priority Data
May 26, 2023 (SE) 2330241-7

(51) Int. Cl. C25B 1/04; C25B 1/50

(52) U.S. Cl. CPC C25B 1/04; C25B 1/50

(57) ABSTRACT

Disclosed are methods and devices for the production of hydrogen gas by splitting a media flow containing sodium ions or other metal ions in an aqueous solution, wherein the ion-splitting effect of a magnetic field is enhanced by the arrangement of a controllable electric field generated between electrodes by means of a voltage source which extends within the magnetic field and the force direction of which coincides with the direction of the force that the magnetic field imposes on the ions in the media flow. The electric voltage source is connected in series with the electrodes.

### TECHNICAL FIELD OF THE INVENTION

The present invention relates to a method for producing hydrogen gas by splitting water by means of sodium ions or other metal ions in an aqueous solution, and a device for carrying out the method.

Production of hydrogen gas has gained increasing importance in a large number of different contexts. It can be mentioned that hydrogen gas can primarily be used in the process industry, e.g. to produce fossil-free steel. Heavy transport that is difficult to electrify is another area with great potential. A third area is to use hydrogen gas to smooth out peaks and valleys in the power system. In the process industry, hydrogen can be used, among other things, to replace fossil energy. In the production of steel, for example, large amounts of coal or natural gas are used today, which react chemically with the iron ore. The challenge has been to find a fossil-free manufacturing method. There, the hydrogen enters as a solution.

Hydrogen gas can be produced by electrolysis, e.g. using renewable electricity that splits water, by reforming fossil fuels (natural gas, coal), biomass (solid biofuel, organic waste, biogas) or by gasification. These methods are, however, expensive to apply, partly due to high investment costs in the facilities for them, partly due to high operating costs in the form of high energy consumption, large work inputs, and high maintenance costs.

A method and a device for deionizing a liquid or gaseous medium which is caused to flow through a magnetic field arranged essentially perpendicular to the direction of flow is previously known from the Swedish patent document with publication number SE405687, which is hereby incorporated in its entirety by reference and from which attached FIG. 1 is retrieved.

### SUMMARY OF THE INVENTION

An object of the present invention is to provide a method for economically and energy-efficiently producing hydrogen gas from water as well as a device for carrying out the method, whereby the following advantages are achieved in relation to previously known methods: lower installation cost for the hydrogen production equipment, substantially reduced maintenance requirements, substantially reduced need for supervision and other manual work, as well as lower energy consumption.

The object of the invention is achieved by a method of the type indicated in the above introduction, in which a medium consisting of metal ions in aqueous solution is caused to flow through a magnetic field arranged essentially perpendicular to the direction of flow of the medium, wherein, respectively, negatively and positively charged ions are caused to arrange themselves in a mutually opposite relationship to each other at the peripheries of the media flow, wherein the parts of the media flow that contain a high concentration of positively and negatively charged ions are separated into separate media streams adjacent to the outlet of the media flow out of the magnetic field. The method further includes:
connecting the negative pole of an electric voltage source to a first electrode arranged in contact with the media flow within the magnetic field,
connecting the positive pole of the electric voltage source to a second electrode arranged in contact with the media flow within the magnetic field,
generation by means of the first and second electrodes and the electric voltage source of an electric field of force perpendicular to the direction of flow of the media flow through the magnetic field, to which the first electrode is arranged in the side of the media flow to which positively charged ions are moved by the influence of the magnetic field, and the second electrode is arranged in the opposite side of the media flow to which negatively charged ions are moved by the influence of the magnetic field, so that the force direction of the electric field of force thus coincides with the direction of the force imposed by the magnetic field on the ions in the media flow within the magnetic field, thereby enhancing the separation of negative and positive ions.

It should be noted here that the magnetic field itself does not exert the force on the ions. Instead, it is the interaction between the charge of the ion, its speed and the magnetic field that results in a force acting on the ions.

In one embodiment, the electric field of force generated by the first and second electrodes is extended downstream of the magnetic field as seen in the direction of flow of the media flow, by arranging extension parts of the electrodes a certain distance into the separated media streams.

In a preferred embodiment, the field strength of the generated electric field of force is controllable.

In a preferred embodiment, the separated media streams are returned to a common media container or media tank connected upstream of the magnetic field for renewed feeding/circulation via separation tanks for the separation of hydrogen gas and oxygen gas, respectively.

The separated media streams may, in an alternative embodiment, be returned to the respective pipelines connected upstream of the magnetic field for renewed feeding/circulation via separation tanks for the separation of hydrogen gas and oxygen gas, respectively.

The object of the invention is also achieved by means of a device for producing hydrogen gas by splitting a media flow containing sodium ions or other metal ions in aqueous solution, the device comprising:
a tubular means for transporting the media flow through a magnetic field formed by a magnetic means, which magnetic field has an essentially perpendicular extent in relation to the direction of flow of the media flow through the magnetic field,
a pump effective for driving the media flow through the magnetic field,
a first and a second outlet means for splitting the media flow into separate media streams with positive and negative ion concentration respectively, which outlet means are arranged adjacent to the outlet of the media flow out of the magnetic field, p1 wherein the first and second outlet means are arranged to lead the separated media streams to a first and a second separation tank for separating hydrogen gas and oxygen gas respectively, wherein
a first electrode is arranged in contact with the media flow within the magnetic field and connected to the negative pole of an electric voltage source,
a second electrode is arranged in contact with the media flow within the magnetic field and connected to the positive pole of the electric voltage source, wherein the first electrode is arranged in the side of the media flow to which positively charged ions are moved by the influence of the magnetic field, and the second electrode is arranged in the opposite side of the media flow, to which negatively charged ions are moved by the influence of the magnetic field,
   wherein, by means of the electrodes and the electric voltage source, an electric field of force is generated whose force direction coincides with the direction of the force that the magnetic means imposes on the ions in the media flow within the magnetic field, thereby enhancing the separation of negative and positive ions.

In a preferred embodiment, the electric voltage source may consist of a battery or a rectifier and be arranged for output of a controllable direct voltage.

In one embodiment, the first electrode extends out of the magnetic field and exhibits an extension portion that runs along an inside of the first outlet means, and wherein the second electrode correspondingly extends out of the magnetic field and exhibits an extension portion that runs along an inside of the second outlet means.

In one embodiment, the extension part of the first electrode exhibits an electrode gate oriented transversely to the media stream in the first outlet means and flowed through by media, and the extension part of the second electrode correspondingly exhibits an electrode gate oriented transversely to the media stream in the second outlet means and flowed through by media.

In the above-mentioned embodiments, the electric voltage source is connected in series with the electrode gates.

In one embodiment of the device, the separation tanks are in flow connection with a common media container or tank to which water may be refilled to replace the hydrogen gas and oxygen gas produced in the device, wherein the media container or tank is connected to said tubular member for renewed feeding/circulation of the media flow in the device.

In an alternative embodiment, the separation tanks may be in flow connection with said tubular member upstream of the magnetic means via respective pipelines with a suitable connection for refilling water.

### BRIEF DESCRIPTION OF THE DRAWINGS

The method according to the present invention for producing hydrogen gas from water by splitting water by means of sodium ions or other metal ions in an aqueous solution, together with a device for carrying out the method, will be described in more detail below with reference to attached schematic drawings of exemplary embodiments.

FIG. 1 shows the device known from SE405687 for deionizing a media flow,

FIG. 2 shows a device for producing hydrogen gas according to an embodiment of the invention as seen from above, and

FIG. 3 shows an exploded detail of the device of FIG. 2 as seen from above.

### DETAILED DESCRIPTION OF PREFERRED EMBODIMENTS

The reference numeral 1 in the figures denotes a magnetic means arranged to produce a magnetic field 2. The magnetic field 2 is perpendicularly directed in relation to a pipeline 3 made of a non-magnetic material. The magnetic field of force 2 thus cuts the pipeline 3 perpendicularly to the flow direction S for a gas or liquid medium fed through the pipeline 3, in particular water with dissolved metal ions such as sodium hydroxide ions. Adjacent to the point where the pipeline 3 exits from the magnetic field 2, this passes into two outlet means 5 and 6 arranged at the connection point to the pipeline 3 in a mutually parallel relationship. From a flow point of view, the reference numeral 3 can thus still denote the medium flow which is caused to pass through the magnetic field 2, whereas correspondingly the reference numerals 5 and 6 can also denote the split media streams which pass through the outlet means.

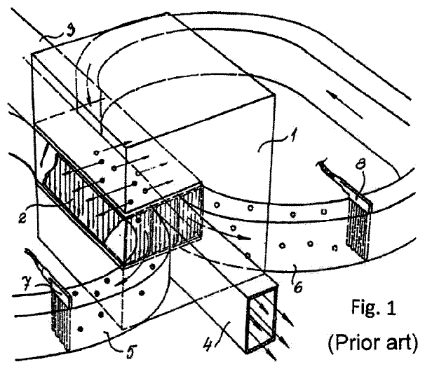

In this context, it can be mentioned that a third outlet means 4 (see FIG. 1), where appropriate, and in a manner known per se, may be arranged for the removal of a central media stream.

In the respective outlet means 5 and 6, deionization means 7 and 8 are respectively arranged. These deionization means 7 and 8 may have the form of grids or gates in a manner corresponding to that of the known device.

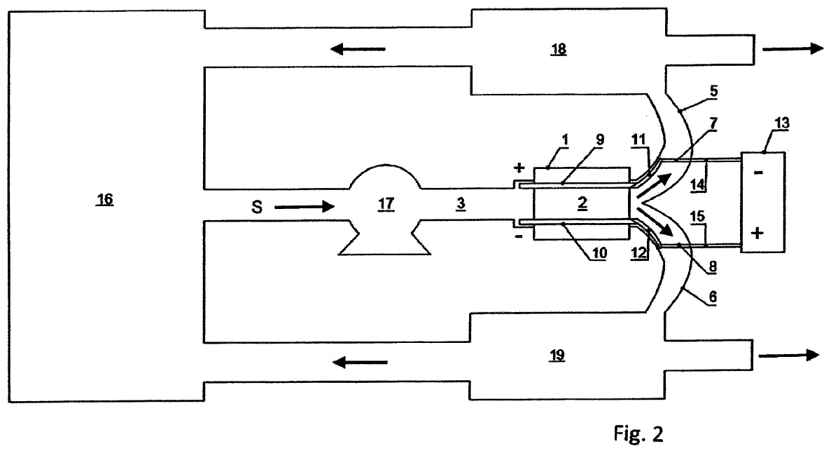

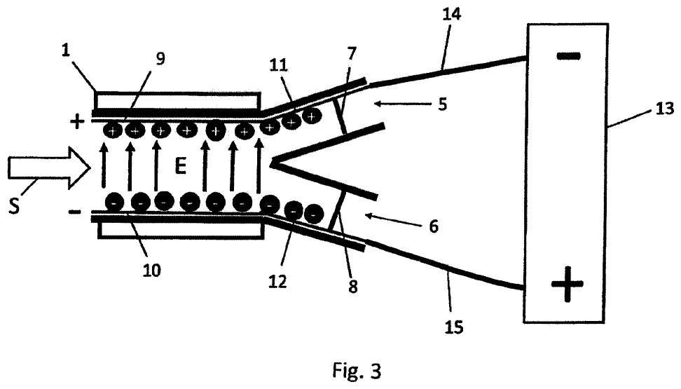

The magnet means 1 may consist of e.g. a C or E-shaped magnet, or a magnet shaped in a different way through whose air gap a pipeline 3 with a rectangular cross-section is arranged. To facilitate the understanding of the present invention, said magnet 1 is hereby assumed to be arranged with the magnetic north pole at the upper part of the air gap, and with the magnetic south pole arranged at the lower part of the air gap. This creates a magnetic field 2 with a field direction that is oriented perpendicular to the media flow 3 and perpendicular to the drawing plane in FIGS. 2 and 3.

Under the influence of the magnetic field 2, a splitting of negative and positive ions (such as OH⁻ and Na⁺ in aqueous solution) occurs in the medium flowing through the pipeline 3, wherein positive ions are moved in a lateral direction in relation to the flow direction S, whereas negative ions are moved in the other lateral direction as illustrated in FIG. 3.

The force F acting on the ions in a magnetic field is dependent on the charge q of the ion and velocity v perpendicular to the magnetic field as well as the magnetic flux density B according to the equation F=q×v×B. This results in a fractionation of the media flow, wherein the positive ions (such as Na⁺) are concentrated to the media stream in the upper outlet device 5 in FIGS. 2 and 3, whereas the negative ions (such as OH⁻) are concentrated to the media stream in the lower outlet means 6 in FIGS. 2 and 3. It should be noted here that FIGS. 2 and 3 show the device as seen from above, and that the outlet means 5 and 6 are in practice located side by side so that the outlet means 5, as seen in the flow direction S, constitutes the outlet means opening out in the left side of the media stream, whereas the outlet means 6 constitutes the outlet means opening out in the right side of the media stream.

The deionization means 7 and 8 which are arranged in the outlet means 5, 6 allow utilization of existing sub-components (O₂ and H₂ respectively) through oxidation and reduction, respectively, of the ions included in the media flow (OH⁻ and Na⁺, respectively).

According to the shown embodiment of a device according to the invention, the deionization means 7 and 8 are electrically connected to the respective electrodes 9 and 10. The electrodes 9 and 10 are arranged in a mutually opposite relationship in the pipeline 3 within the magnetic field 2, wherein the electrodes 9 and 10 extend at the outer, vertical boundary lines of the pipeline 3. The electrodes 9 and 10 preferably extend into and through the magnetic field 2 from a point upstream to a point downstream of the magnetic field 2.

In this way, an enhancement of the splitting of positive and negative ions is achieved through the incorporation of two attracting electric poles, which brings about a more efficient separation of positively and negatively charged ions, respectively, in the media flow 3 and also compensates for and overcomes an oppositely directed electric field arising due to the separation of ions within the magnetic field 2.

An example of how hydrogen gas and oxygen gas are generated will be described in more detail below and with reference to FIG. 3, in which the ionized medium consists of an alkaline earth metal hydroxide, for example Na⁺OH⁻. The ion solution is caused to flow through the device in the pipeline 3 that extends through the magnetic field 2. This causes the ions to be separated in the previously described manner, so that the concentration of Na⁺ increases in one side portion of the pipeline 3, whereas the concentration of OH⁻ increases in the opposite side portion. In other words, an excess of positively charged Na⁺ ions occurs in the upper outlet means 5, whereas an excess of negatively charged OH⁻ ions occurs in the lower outlet means 6.

If an electric conductor 11, which may also be seen as an extension of the electrode 9, is connected between the deionization means 7 and the associated electrode 9, and an electric conductor 12, which may also be seen as an extension of the electrode 10, is connected between the deionization means 8 and the associated electrode 10, an electric field E is generated in the pipeline 3 perpendicular to the direction of movement of the media flow within the magnetic field 2. It should be clarified here that the force direction of the generated electric voltage field E coincides with the direction of the force that the magnet 1 imposes on the ions within the magnetic field 2.

This causes generation of an efficient and enhanced transfer of electrons between the electrodes 10 and 9, and a voltage-raising effect generated by the magnetic field 2 and said electrodes.

In order to enhance the transfer of electrons from the electrode 10 to the electrode 9, according to the invention, an external electric voltage source 13 is introduced which is connected directly or indirectly to the respective electrodes 9 and 10 within the magnetic field by means of electric conductors 14, 15.

In a preferred embodiment, the electric conductors 14, 15 may be connected in series with the deionization means 7 and 8, and which are thus electrically connected in series with the electrodes 9 and 10 within the magnetic field 2, via the respective electric conductor/electrode 11 and 12.

The voltage source 13 may here be compared to an electron generator and acts as an electron pump. The positive pole of the electron pump attracts electrons from the electrode 10 (or, as the case may be, electrodes 8, 10, 12) and indirectly electrons from the negatively charged ions (OH⁻ ions). The negative pole of the electron pump is connected to the electrode 9 (or, as the case may be, electrodes 7, 9, 11) to which electrons flow from the negative pole. The electrons react with the positively charged ions (Na⁺ ions). The electrons thus do not essentially pass through the water solution, but through the electron pump, which enhances the transfer of electrons from electrode 10 to 9.

The electrode 9, the conductor/electrode 11 and the deionization means/electrode 7 may be electrically regarded as a continuous electrode which extends the electric field E a certain distance into the outlet means 5. Correspondingly, the electrode 10, the conductor/electrode 12 and the deionization means/electrode 8 may be electrically regarded as a continuous electrode which extends the electric field E a certain distance into the outlet means 6. According to this aspect of the device, the deionization means 7 and 8, through their design preferably as grids or gates, may be considered as an extension of the electrodes 9 and 10 in the form of a respective electrode gate 7 and 8 which are oriented across the direction of flow in the outlet means 5 and 6 and are therefore flowed through by the media streams 5 and 6.

The external voltage source 13 may consist of one or more batteries or rectifiers and may be arranged to create a voltage potential with variable strength across the electrodes 9 and 10, as well as, where appropriate, across the electric conductors/electrodes 11 and 12 and across the deionization means/electrodes 7 and 8. This creates a controllable electric field which increases the ion separation within the pipeline 3, thus making the generation of hydrogen gas more efficient.

The voltage potential across the electrodes 9, 10, and/or across the electrodes 11, 12 and, where appropriate, across the deionization means 7, 8, may be arranged controllable within a range of 0 -300 volts direct current. In the practical implementation of the invention, it may be predicted that the voltage potential will, in a normal case, be regulated within a narrower range, such as 80-120 volts, for example.

The deionization means/electrodes 7, 8 may thus be connected to the electrodes 9 and 10 arranged in the magnetic field via electrodes 11, 12 fully or partially arranged along the peripheries in the respective outlet parts 5, 6 as extensions of the respective electrodes 9 and 10.

The deionization means/electrodes 7, 8 may also alternatively be connected to the electrodes 9 and 10 arranged in the magnetic field via electric conductors.

For the production of 1 kg of H₂ per hour by splitting, in the described manner, a medium containing sodium hydroxide NaOH in aqueous solution to H₂ and O₂, 4.60983*10¹⁹ electrons per second need to be transferred from electrode 10 (preferably electrodes 8, 10 and 12), where OH⁻ is oxidized to O₂ and H₂O, to electrode 9 (preferably electrodes 7, 9 and 11), where Na⁺ is reduced to Na which reacts with water and forms 2H₂+4OH⁻ (see further below).

Tests have shown that 1 kg of H₂ can be generated from 8.94 kg of water at a very favorable energy consumption compared to conventional electrolysis methods: more specifically, hydrogen production according to the invention requires only minimal energy per kg of H₂ compared to a many times greater energy requirement for production of the same amount of hydrogen gas according to conventional electrolysis.

During energy conversion of the hydrogen gas, 1 kg of hydrogen reacts with oxygen and again forms 8.94 kg of water.

Hydrogen gas has an energy density of approx. 120 MJ/kg, nearly three times more than diesel or petrol. As a form of energy, hydrogen is comparable to 33.6 kWh of electrical energy per kg. For comparison, diesel has an energy density of approx. 12-14 kWh per kg.

From a media container or tank 16, which may also be a pipeline for circulation of the medium, a water-ion solution is pumped through the device by means of a circulation pump 17 and new medium is added to the media container to compensate for the water that has been split into hydrogen gas and oxygen gas. The circulation pump 17 is preferably arranged in connection with the pipeline 3 as illustrated in FIGS. 2 and 3.

The generated hydrogen gas is separated via the outlet means 5 to a separation tank 18 for hydrogen gas. The generated oxygen gas is separated via the outlet means 6 to a separation tank 19 for oxygen gas. From the separation tanks 18 and 19, the water-ion solution is returned to the media container 16 for renewed feeding via the circulation pump 17 through the pipeline 3, the magnetic field 2 and past the electrodes 9(11) and 10(12) and through the respective deionization means/electrode gates 7 and 8.

Calculations and tests indicate that only a thin layer of the water-ion solution passing through the magnetic field and in close proximity to the electrodes is affected.

To generate 9.67 kg of hydrogen gas per hour, the amount of water and energy required may be calculated as follows:
86.4 kg of water, 3.92 kWh for the circulation pump 17, 1.47 kWh for the magnet 1 and 1.70 kWh for the electron pump 13.

At the deionization means/electrode 7 and close to the electrode 9 and, where applicable, the electrode 11 in the outlet means 5 with a high concentration of Na⁺, one electron per Na⁺ is absorbed in a simultaneous reaction with water according to:

4Na⁺+4e=>4Na

4Na+4H₂O=>4Na⁺+4OH⁻+2H₂

At the deionization means/electrode 8 and close to the electrode 10 and, where applicable, the electrode 12 in the outlet means 6 with a high concentration of OH⁻ ions, one electron is released per OH⁻ according to:

4OH⁻−4e=>2H₂O+O₂

The hydrogen gas and oxygen gas produced in this way at the electrodes are utilized and separated in the respective separation tanks 18 and 19.

The shown embodiments are only intended to schematically illustrate embodiments of the method and device according to the present invention, and modifications within the framework of the inventive idea specified in the subsequent patent claims are possible.

As magnet means 1, all known types of magnets, both permanent magnets and electromagnets, may be used. The use of permanent magnets entails obvious advantages, so that the energy consumption when carrying out the method according to the present. invention is thereby further reduced.

1. A method for producing hydrogen gas by splitting a media flow containing sodium ions or other metal ions in an aqueous solution, wherein the media flow is driven to flow through a magnetic field generated essentially perpendicular to the direction of flow of the media flow, wherein negative and positively charged ions are caused to arrange themselves in an opposite relationship to each other at the peripheries of the media flow, wherein the parts of the media flow that contain a high concentration of positively and negatively charged ions, respectively, are separated into separate media streams adjacent to the media flow exiting the magnetic field, wherein the method includes:
connection of the negative pole of an electric voltage source to a first electrode arranged in contact with the media flow within the magnetic field;
connection of the positive pole of the electric voltage source to a second electrode arranged in contact with the media flow within the magnetic field; and
generation by means of the electrodes and the electric voltage source of an electric field of force perpendicular to the flow direction of the media flow through the magnetic field, to which the first electrode is arranged in the side of the media flow to which positively charged ions are moved by the influence of the magnetic field, and the second electrode is arranged in the opposite side of the media flow to which negatively charged ions are moved by the influence of the magnetic field, so that the force direction of the electric field of force coincides with the direction of the force that the magnetic field imposes on the ions in the media flow, thereby enhancing the separation of negative and positive ions.

2. A method according to claim 1, wherein the electric force field is extended downstream of the magnetic field as seen in the flow direction of the media flow by arranging extension parts of the electrodes a certain distance into the separated media streams.

3. A method according to claim 1, wherein the field strength of the electric field of force is arranged controllable.

4. A method according to claim 1, wherein the separated media streams are returned to a common media container connected upstream of the magnetic field for renewed feeding/circulation via separation tanks for separation of hydrogen gas and oxygen gas, respectively.

5. A device for producing hydrogen gas by splitting a media flow containing sodium ions or other metal ions in an aqueous solution, wherein the device comprises:
a tubular member for transporting the media flow through a magnetic field formed by a magnetic means, which magnetic field has an essentially perpendicular extent in relation to the flow direction of the media flow through the magnetic field;
a pump active for driving the media flow through the magnetic field;
a first and a second outlet means for splitting the media flow into separate media streams with positive and negative ion concentration, respectively, which outlet means are arranged adjacent to the outlet of the media flow out of the magnetic field, wherein the first and second outlet means are arranged to lead the separated media streams to a first and a second separation tank for separating hydrogen gas and oxygen gas;
a first electrode is arranged in contact with the media flow within the magnetic field and connected to the negative pole of an electric voltage source; and
a second electrode is arranged in contact with the media flow within the magnetic field and connected to the positive pole of the electric voltage source, wherein the first electrode is arranged in the side of the media flow to which positively charged ions are moved by the influence of the magnetic field, and the second electrode is arranged in the opposite side of the media flow, to which negatively charged ions are moved by the influence of the magnetic field, whereby the electrodes and the electric voltage source generate an electric field of force, whose force direction coincides with the direction of the force that the magnetic means imposes on the ions in the media flow within the magnetic field, thereby enhancing the separation of negative and positive ions.

6. A device according to claim 5, wherein the electric voltage source consists of a battery or a rectifier and is arranged to output a controllable direct voltage.

7. A device according to claim 5, wherein the first electrode extends out of the magnetic field and has an extension part running along an inside of the first outlet means, and wherein the second electrode in a corresponding way extends out of the magnetic field and has an extension part running along an inside of the second outlet means.

8. A device according to claim 7, wherein the extension part of the first electrode has an electrode gate oriented transversely to the media stream in the first outlet means and through which the media flows, and wherein the extension part of the second electrode has an electrode gate oriented transversely to the media stream in the second outlet means and through which the media flows.

9. A device according to claim 8, wherein the electric voltage source is connected in series with the electrode gates and.

10. A device according to claim 5, wherein the separation tanks are in flow connection with a common media container which is connected to said tubular member.
